(19) United States
(12) Patent Application Publication
(10) Pub. No.: US 2022/0284467 A1
(43) Pub. Date: Sep. 8, 2022

(54) Methods, Systems and Computer Program Products for Tracking and Attributing Conversion Events

(71) Applicant: Bluestack Systems, Inc., Campbell, CA (US)

(72) Inventor: Lokesh Setia, Gurugram (IN)

(21) Appl. No.: 17/688,248

(22) Filed: Mar. 7, 2022

Related U.S. Application Data
(60) Provisional application No. 63/189,827, filed on May 18, 2021.

(30) Foreign Application Priority Data
Mar. 7, 2021 (IN) 202111009483

(51) Int. Cl. G06Q 30/02; G06F 8/61; H04L 9/40

(52) U.S. Cl. CPC G06Q 30/0246; G06F 8/61; H04L 63/0876

(57) ABSTRACT

The present invention relates to conversion event tracking and attribution. The invention enables measuring the impact of marketing events on distribution and adoption of software products and/or services and attribution of a conversion event to a source that is responsible for that conversion. The invention additionally enables optimization of targeted traffic/content delivery to users based on accurate tracking and attribution of conversion events. The invention is implemented by a conversion tracking server configured for network communication with a users terminal device and optionally for network communication a cloud services server system, to implement conversion event tracking and attribution.

### CROSS-REFERENCE TO RELATED APPLICATIONS

This application claims priority to Indian Patent Application No. 202111009483 filed Mar. 7, 2021, and U.S. Provisional Application No. 63/189,827 filed May 18, 2021, the disclosures of which are hereby incorporated by reference in their entirety.

### FIELD OF THE INVENTION

The present invention relates to conversion event tracking and attribution. The invention enables measuring the impact of marketing events on distribution and adoption of software products and/or services and attribution of a conversion event to a source that is responsible for that conversion. The invention additionally enables optimization of targeted traffic/content delivery to users based on accurate tracking and attribution of conversion events.

### BACKGROUND

An advertisement is converted when a viewer initiates an action desired by the advertiser, such as for example, purchasing a product, service, or subscription featured in the advertisement, or engaging in additional research of the product or service (such as visiting the advertiser's or seller's website) or any other action indicative of user engagement with the advertisement. Since the purpose of an advertising campaign is to generate demand for a product service offering among consumers, information on whether an advertisement is converted is important to determining whether the advertising campaign is successful. Additionally, when a product/service offering is being advertised by multiple ad networks or ad agencies, and the applicable payment models involve paying an ad network or agency only if an advertisement is successfully converted, it is also important to be able to attribute a successful conversion to the ad network or ad agency that caused the conversion.

For successful conversion tracking and attribution, merchants require to be able to predictably identify each instance where a user interacted with their ads, and even each time a consumer makes a download or a purchase, or an application launch after viewing an advertisement.

When an advertisement is displayed on a mobile device, the situation is yet more complicated. FIG. 1 illustrates a conventional method through which advertisement conversion and attribution is achieved for mobile devices.

As shown in FIG. 1, an advertisement 1022 (for example for a downloadable software application) is displayed on a mobile device 102. The displayed advertisement 1022 includes an embedded link 1024 which is configured to respond to a user clicking on the advertisement by (i) retrieving an identifier (such as an ‘identifier for advertisers (IDFA) made available in the iOS system for Apple mobile devices/iPhones) associated with the mobile device 1022 and (ii) transmitting to an attribution platform 104, the identifier along with information identifying an ad network or ad agency or other entity responsible for displaying the advertisement 1022 on the mobile device 102, and information confirming that the advertisement 1022 displayed on the mobile device 102 has been clicked or viewed.

The attribution platform 104 receives this information from the mobile device 102, and is able to record a first conversion event—i.e. that the advertisement 1022 displayed by a specific ad network or ad agency has been clicked by a user. Subsequently, if the user views the advertisement 1022 and decides to download an advertised software application 1026 onto the mobile device 102, the user is directed to a download resource 106 or repository (such as Apple's ‘app store’ platform’) and is able to download the advertised software application 1026 onto the mobile device 102.

When the user launches the installed application 1026, an SDK 1028 or other software file/data file/library file within the installed application 1026 (i) retrieves the same identifier (e.g. the IDFA) associated with the mobile device 102 and (ii) transmits to the attribution platform 104, the identifier along with information confirming that the software application 1026 has been launched for the first time on the mobile device 102.

As shown in FIG. 2, by matching the two identifiers received at the attribution platform 104, it is possible to ascertain that an install and launch of a software application 1026 on a particular mobile device 102 is a consequence of an advertisement 1022 displayed on that mobile device 102 by a specific ad network or ad agency, so that the installation can be attributed to that ad network or ad agency and appropriate credit may be assigned.

The conventional methods for tracking and attribution of conversion events on mobile devices are undergoing changes—and there are increasingly, restrictions on retrieval of identifiers associated with a mobile device and passing of such identifiers and other information to third parties. Such restrictions significantly restrict the ability to track and properly attribute conversion events involving mobile devices.

As a solution for enabling conversion and attribution tracking, certain operating system vendors (such as Apple) have indicated that software applications having a common publisher or vendor can freely interchange device specific information with each other. Each (User, Vendor) tuple will be assigned a random identifier, known as an IDFV (see https://www.adjust.com/glossary/idfv/) (Identifier for Vendors), which can be used if both the originating and new application are from the same vendor or publisher. This has opened up opportunities for publishers of software applications to have their own advertisement publishing sources (for example popular software applications or games published by a developer/publisher), through which accurate advertisement tracking measurements can be done. However, even with this solution, the potential reach for advertisers would be limited to the user base of the software application or game.

There is accordingly a need for new methods of tracking and attribution that eliminate the reliance on existing systems of identification (such as IDFAs). There is additionally a need to enable the ‘common vendor/publisher’ relationship which allows users to be identified via an IDFV, to be extended to web browser to application conversions.

### SUMMARY

The invention enables tracking and attribution of software application related conversion events, to a source that is responsible for that conversion.

The invention provides a method for network based tracking of electronic advertisement conversion, comprising implementing at a conversion tracking server, the steps of (i) receiving, from a referral source that has initiated display of an advertisement for a software application on a terminal device web browser, traffic parameters associated with a user click event corresponding to the displayed advertisement, (ii) responsive to receiving, from the terminal device, a first user input initiating network based delivery of a cloud implemented instance of the software application to the terminal device (a) generating a unique identifier associated with an ongoing network communication session between the terminal device and the conversion tracking server, (b) generating a first device fingerprint associated with the terminal device, (c) associating the generated first device fingerprint with the generated unique identifier, (d) retrievably storing the generated first device fingerprint with the generated first unique identifier in a device fingerprint database; and (e) transmitting to the referral source or to an entity associated with the referral source, a first conversion event confirmation message confirming that delivery of the cloud implemented instance of the software application to the terminal device has been initiated, (iii) receiving, from the terminal device, a second user input initiating download of the software application onto the terminal device, and implementing download of the software application from an application store database, onto the terminal device, (iv) responsive to launch of a runtime instance of the downloaded software application on the terminal device (f) receiving from the terminal device, a runtime event confirmation message, (g) receiving from the terminal device, terminal device fingerprint data, (h) generating a second device fingerprint based on the received terminal device fingerprint data, (i) comparing the second device fingerprint against device fingerprint data stored in the device fingerprint database, (j) responsive to detecting a positive match between the second device fingerprint and the first device fingerprint (1) retrieving the unique identifier associated with the first device fingerprint, and (2) transmitting to the referral source or to the entity associated with the referral source, a second conversion event confirmation message confirming launch of the runtime instance of the downloaded software application on the terminal device.

The invention also provides a system for network based tracking of electronic advertisement conversion, comprising a processor based conversion tracking server configured for implementing the steps of (i) receiving, from a referral source that has initiated display of an advertisement for a software application on a terminal device web browser, traffic parameters associated with a user click event corresponding to the displayed advertisement, (ii) responsive to receiving, from the terminal device, a first user input initiating network based delivery of a cloud implemented instance of the software application to the terminal device (a) generating a unique identifier associated with an ongoing network communication session between the terminal device and the conversion tracking server, (b) generating a first device fingerprint associated with the terminal device, (c) associating the generated first device fingerprint with the generated unique identifier, (d) retrievably storing the generated first device fingerprint with the generated first unique identifier in a device fingerprint database; and (e) transmitting to the referral source or to an entity associated with the referral source, a first conversion event confirmation message confirming that delivery of the cloud implemented instance of the software application to the terminal device has been initiated, (iii) receiving, from the terminal device, a second user input initiating download of the software application onto the terminal device, and implementing download of the software application from an application store database, onto the terminal device, (iv) responsive to launch of a runtime instance of the downloaded software application on the terminal device (f) receiving from the terminal device, a runtime event confirmation message, (g) receiving from the terminal device, terminal device fingerprint data, (h) generating a second device fingerprint based on the received terminal device fingerprint data, (i) comparing the second device fingerprint against device fingerprint data stored in the device fingerprint database, (j) responsive to detecting a positive match between the second device fingerprint and the first device fingerprint (1) retrieving the unique identifier associated with the first device fingerprint, and (2) transmitting to the referral source or to the entity associated with the referral source, a second conversion event confirmation message confirming launch of the runtime instance of the downloaded software application on the terminal device.

The invention also provides a computer program product for network based tracking of electronic advertisement conversion. The computer program product comprises a non-transitory computer readable medium having a computer readable program code embodied therein, the computer readable program code comprising instructions for implementing the steps of (i) receiving, from a referral source that has initiated display of an advertisement for a software application on a terminal device web browser, traffic parameters associated with a user click event corresponding to the displayed advertisement, (ii) responsive to receiving from the terminal device, a first user input initiating network based delivery of a cloud implemented instance of the software application to the terminal device (a) generating a unique identifier associated with an ongoing network communication session between the terminal device and the conversion tracking server, (b) generating a first device fingerprint associated with the terminal device, (c) associating the generated first device fingerprint with the generated unique identifier, (d) retrievably storing the generated first device fingerprint with the generated first unique identifier in a device fingerprint database; and (e) transmitting to the referral source or to an entity associated with the referral source, a first conversion event confirmation message confirming that delivery of the cloud implemented instance of the software application to the terminal device has been initiated, (iii) receiving, from the terminal device, a second user input initiating download of the software application onto the terminal device, and implementing download of the software application from an application store database, onto the terminal device, (iv) responsive to launch of a runtime instance of the downloaded software application on the terminal device (f) receiving from the terminal device, a runtime event confirmation message, (g) receiving from the terminal device, terminal device fingerprint data, (h) generating a second device fingerprint based on the received terminal device fingerprint, data, (i) comparing the second device fingerprint against device fingerprint data stored in the device fingerprint database, (j) responsive to detecting a positive match between the second device fingerprint and the first device fingerprint (1) retrieving the unique identifier associated with the first device fingerprint, and (2) transmitting to the referral source or to the entity associated with the referral source, a second conversion event confirmation message confirming launch of the runtime instance of the downloaded software application on the terminal device.

### BRIEF DESCRIPTION OF THE ACCOMPANYING DRAWINGS

FIGS. 1 and 2 illustrate prior art solutions that have been previously used for tracking and attributing software application conversion events within mobile devices.

FIG. 3 illustrates an exemplary configuration for a cloud based software services system in accordance with the teachings of the present invention.

FIG. 4 is a flow diagram illustrating method steps involved in tracking and attribution of software application related conversion events, in accordance with the teachings of the present invention.

FIG. 5 illustrates a system environment configured for implementing the present invention.

FIG. 6 is a flow diagram illustrating method steps involved in an exemplary embodiment of the invention involving tracking and attribution of software application related conversion events.

FIG. 7 illustrates an exemplary system for implementing the present invention.

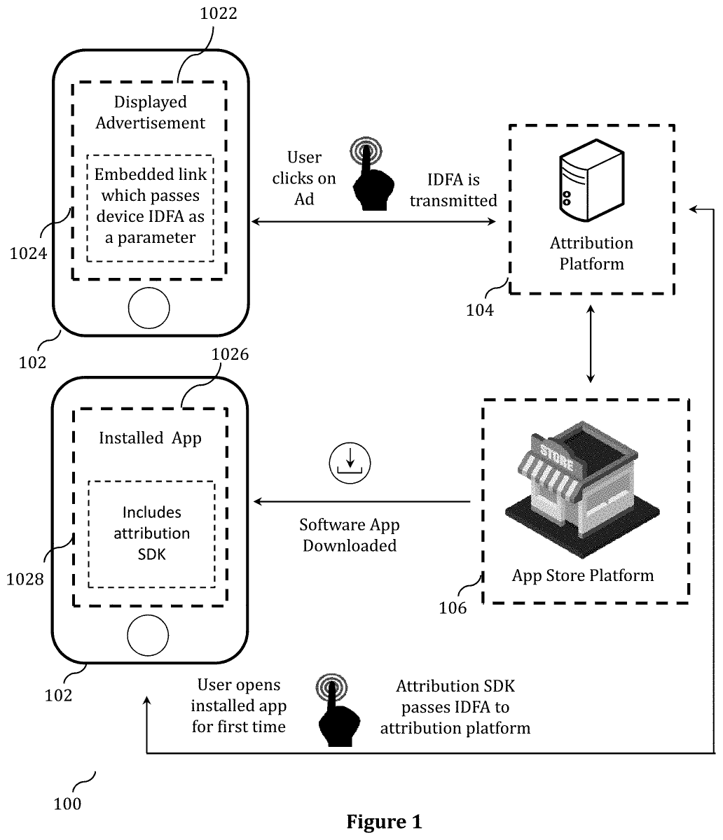

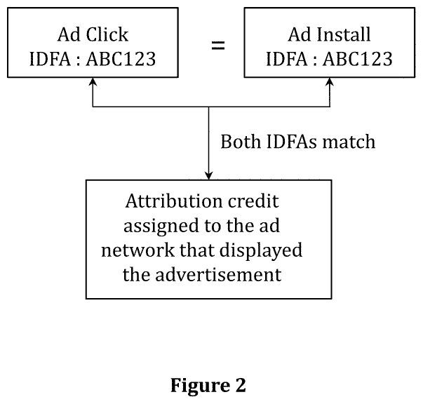

### DETAILED DESCRIPTION

The invention enables tracking and attribution of software application related conversion events, to a source that is responsible for that conversion. The invention additionally enables optimization of targeted traffic/content delivery to users based on accurate tracking and attribution of conversion events.

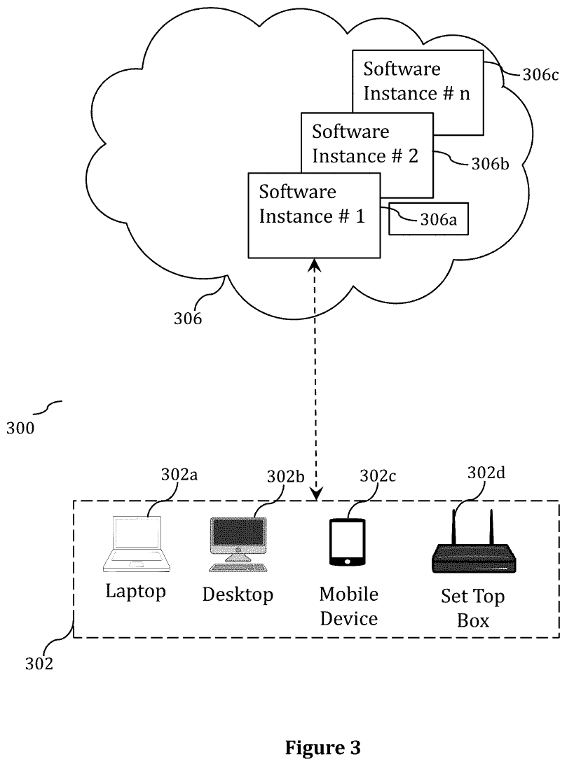

To implement the inventive solution, the invention may inter alia rely on a cloud based software services system—which is briefly described in connection with FIG. 3.

A cloud based software services environment involves remotely located hardware devices that execute a software application and which streaming software application output data to a client device such as a mobile device or other terminal device.

In FIG. 3, system environment 300 comprises one or more client devices 302 (for example, any of laptop 302a, desktop 302b, mobile device 302c and/or set top box 302d) interfacing through a communication network such as a data network or the internet (not shown), with a cloud services server system 306. The cloud services server system 306 may comprise (or may be coupled with) a plurality of discrete or distinct hardware systems—each of which is configured to be provisioned with, and to instantiate and run a discrete instance of one or more software applications. As a result, cloud services server system 306 may utilize the plurality of discrete or distinct hardware systems to simultaneously run software instance #1 (306a), software instance #2 (306b), up to software instance #n (306c)—such that video and/or audio data from each of these software instance 306a to 306c may be streamed to one or more requesting client devices 302a to 302d.

By way of an example:

client device 302a may request cloud services server system 306 for cloud based execution of a first software application—and cloud services server system 306 may respond by (i) instantiating a first instance of this first software application to run on a first hardware system, and (ii) streaming video and/or audio data from the first instance of the first software application to client device 302a.

client device 302b may request cloud services server system 306 for cloud based execution of a second software application (which may be the same as the first software application, or may comprise a different software application)—and cloud services server system 306 may respond by (i) instantiating a second instance of this second software application to run on a second hardware system, and (ii) streaming video and/or audio data from the second instance of the second software application to client device 302a

client device 302c may request cloud services server system 306 for cloud based execution of an n^{th} software application (which may be the same as either of the first or second software applications, or may be different from both)—and cloud services server system 306 may respond by (i) instantiating an n^{th} instance of this n^{th} software application to run on an n^{th} hardware system, and (ii) streaming video and/or audio data from the n^{th} instance of the n^{th} software application to client device 302c.

The cloud services server system 306 may comprise a plurality of hardware systems, each of which is configured to:

enable a software application (that is intended to be made available to client devices by way of cloud services) to be installed thereon

responsive to receiving a request for executing an instance of a software application thereon, instantiating the requested instance of the software application for providing a cloud based software service to a client device

streaming to a client device, video output data and/or audio output data from an instance of a software application that is being executed on the software instance processing hardware system

receiving from a client device, user input or control instructions for controlling an instance of a software application that is being executed on the software instance processing hardware system

controlling an instance of a software application that is being executed on the software instance processing hardware system, based on user input or control instructions received from the client device

The cloud services server system 306 may be configured such that each of the plurality of software instance processing hardware systems #1 to #n (306a, 306b, 306c) are configured for software application(s) (such as gaming applications) to be installed and executed thereon. When an instance of a software application is run on any of the underlying software instance processing hardware systems, software application output data (for example, in a gaming software application, video and audio gameplay data) is streamed from such software instance processing hardware system to a client device, where it is rendered for display and/or audio playback. A user who is operating the receiving client device uses the interface controls of the client device to provide software application inputs—which are streamed back to the executing software instance processing hardware system, and are used as control inputs for the instance of the software application that is being run on the executing software instance processing hardware system.

Each of the software instance processing hardware systems within the cloud services server system 306 may comprise any data processing system, including any of a central processing unit (CPU), or a server, or any component thereof having software application execution capabilities, or a mobile communication device or any component thereof having software application execution capabilities, or an ARM (Advanced RISC Machine) processor/RISC (Reduces Instruction Set Computing) processor/mobile device processor, or any hardware component that includes any such processor and has software application execution capabilities.

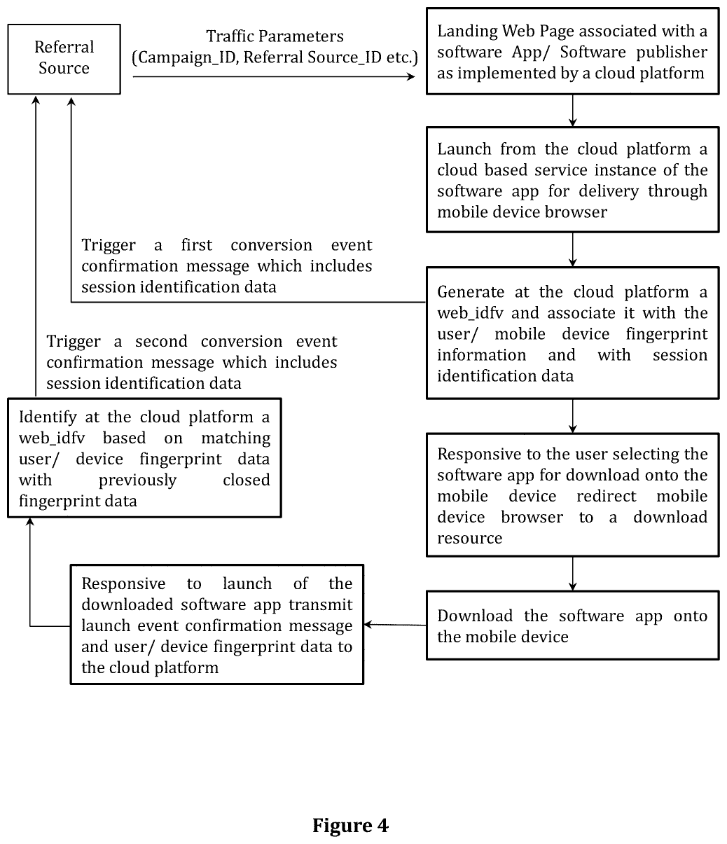

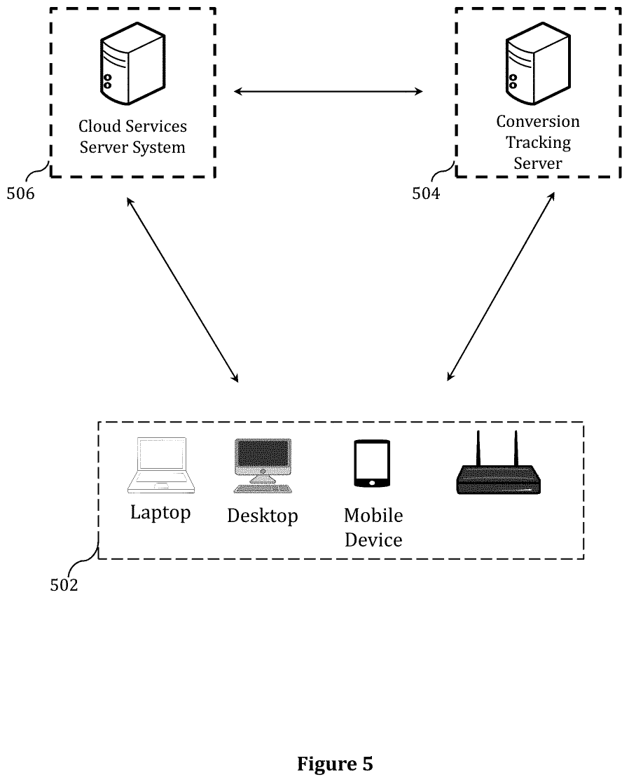

FIG. 4 is a flow diagram illustrating method steps involved in tracking and attribution of software application related conversion events, in accordance with the teachings of the present invention. FIG. 5 illustrates a system environment within which the method of FIG. 4 may be implemented.

As shown in FIG. 4, implementation of the invention may commence when a user of a mobile device/other terminal device 502 initiates viewing of an advertisement for a software application by interacting with a referral source. The referral source may comprise a referral source consisting of a software application on the mobile device/terminal device 502 that is displaying an in-application advertisement, or consisting of a website or webpage on which an advertisement is displayed.

The displayed advertisement includes underlying code or an embedded link which is configured to respond to a user clicking, tapping on, or otherwise interacting with the displayed advertisement through a web browser on the mobile device/terminal device, by redirecting the browser to a webpage (e.g. a landing webpage) associated with the advertised software application or with a publisher of the software application. The webpage may be hosted by a conversion tracking server 504 configured to implement the teachings of the present invention. In an embodiment, clicking on the displayed advertisement results in the referral source obtaining and transmitting traffic parameters associated with the click event to the conversion tracking server 504 at which the landing webpage 404 is implemented. Examples of traffic parameters may include a campaign ID associated with the clicked advertisement, and a referral source ID associated with the referral source.

Upon being redirected to the landing webpage, the user of the mobile device/terminal device 502 is presented with the option of interacting with a cloud based instance of the advertised software application, and responsive to receiving an appropriate user input/click event (for example, by clicking on a ‘PLAY ONLINE NOW’ button) the conversion tracking server 504 instantiates a cloud implemented instance of the software application, and accordingly initiates delivery of a cloud based software experience to the mobile device/terminal device 502 through a cloud services server system 506 (for example, in the manner briefly described in connection with FIG. 3 above).

Responsive to initiation of an instruction for instantiation and delivery of a cloud implemented instance of the software application to the mobile device/terminal device 502, the conversion tracking server 504:

Generates a unique identifier (for example, an identifier named ‘web_idfv’) associated with the ongoing communication session between the mobile device/terminal device 502 and the conversion tracking server 504

Generates a first device fingerprint associated with the mobile device/terminal device 502, based on data received from the mobile device/terminal device 502 and/or the referral source. The first device fingerprint may be generated using any one or more methods available, and may in particular embodiments be generated based on one or more of the device name (i.e. the name of the mobile device/terminal device), device type, device operating system (OS) version, device IP information, network carrier providing network services to the mobile device/terminal device, etc. to identify a successful application install and to form a digital fingerprint ID that matches defined device attributes.

Associates the first device fingerprint with the unique identifier and retrievably store both in a database along with the association between the two.

Optionally associates at least one of (i) information confirming that the user/mobile device/mobile terminal 502 has initiated delivery of a cloud implemented instance of the software application, and (ii) data identifying the ongoing communication session between the mobile device/terminal device 502 and the conversion tracking server 504—with the unique identifier and/or the first device fingerprint.

Transmits to the referral source (or to an entity related to or identified by the referral source), a first conversion event confirmation message, confirming that the user/mobile device/mobile terminal 502 has initiated delivery of a cloud implemented instance of the software application. The first conversion event confirmation message attributes or credits the cloud implemented instance of the software application to the referral source. In an embodiment, the first conversion event confirmation message may include or be accompanied by data identifying the ongoing communication session between the mobile device/terminal device 502 and the conversion tracking server 504.

Thereafter, in response to the user providing an instruction for local download of the software application onto the mobile device/terminal device 502 (for example, by clicking on a ‘DOWNLOAD NOW’ button), the user/mobile device/terminal device 502 is directed to a download resource or repository (such as Apple's ‘application store’ platform’) and is able to download the advertised software application onto the mobile device/terminal device 502.

When the user launches the downloaded application (i.e. initiates a runtime instance of the downloaded application) on the mobile device/terminal device 502, an SDK or other software file/data file/library file within the installed app, transmits to the conversion tracking server 504 (i) a launch event (or runtime event) confirmation message (confirming that the software application has been run or launched on the mobile device/terminal device 502) and (ii) mobile device/terminal device fingerprint data that can be used for the purposes of generating a device fingerprint (for example, device name, type, OS version, IP, carrier, etc.). It will be understood that the mobile device/terminal device 502 fingerprint data may not require to be explicitly sent, and may instead be extracted by the conversion tracking server conversion tracking 504 from one or more data messages sent from the mobile device/terminal device 502 to the conversion tracking server 504.

Upon receiving the launch event confirmation message, the conversion tracking server 504 either:

generates a second device fingerprint based on the device fingerprint data received from the mobile device/terminal device 502, and compares the second device fingerprint against one or more device fingerprints previously stored in its database (including against the first device fingerprint stored in the database), or

compares the device fingerprint data received from the mobile device/terminal device 502, against device fingerprint data extracted from one or more device fingerprints previously stored in its database (including fingerprint data extracted from the first device fingerprint stored in the database)

responsive to identification of a device fingerprint (for example the first device fingerprint) stored within a database associated with conversion tracking server 504, that matches the device fingerprint data received from the mobile device/terminal device 502, the system ascertains an identifier (for example, an identifier named ‘web_idfv’) associated with the matched device fingerprint (e.g. the first device fingerprint) and/or data identifying a communication session through which the matched device fingerprint (for example the first device fingerprint) was generated.

transmits to the referral source (or to an entity related to or identified by the referral source), a second conversion event confirmation message, (i) confirming that the user/mobile device/terminal device 502 has installed/launched/run a downloaded version of the software application on the user's mobile device/terminal device 502, and (ii) provides information relating to the communication session during which or through which the matched device fingerprint (for example the first device fingerprint) was generated.

The referral source (or to an entity related to or identified by the referral source) receives this second conversion event confirmation message and is able to correlate the second conversion event message with an earlier received first conversion message, by matching the communication session information transmitted along with each of the two messages—and as a result is able to confirm that the installation/launch of the downloaded application can be attributed to the initial referral of the mobile device/terminal device 502 by the referral source to the landing page associated with the software application/software publisher. This enables proper attribution/credit for the download/installation/launch of the software application on the mobile device/mobile terminal.

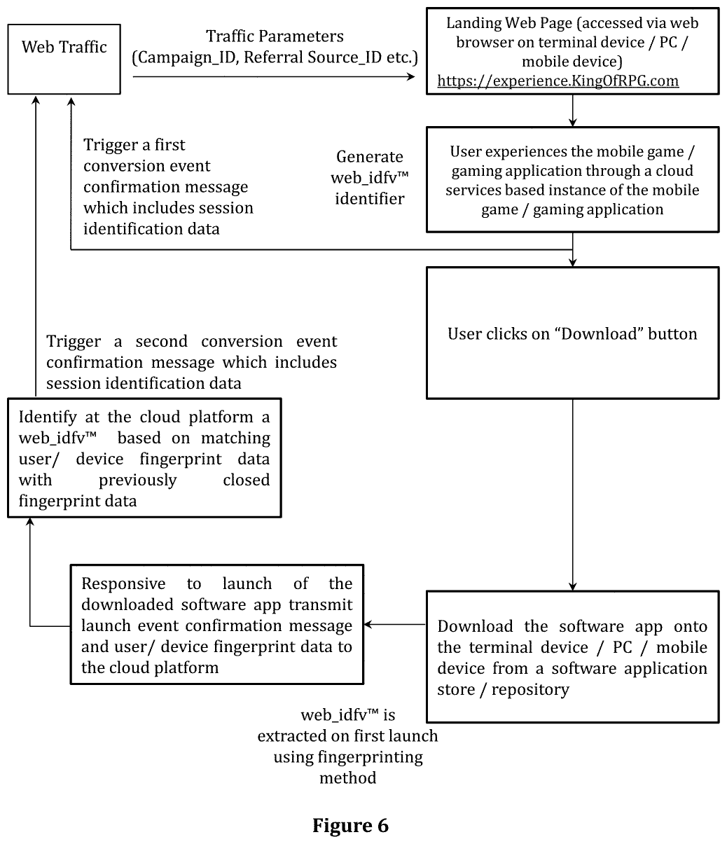

FIG. 6 is a flow diagram illustrating method steps involved in an exemplary embodiment of the invention involving tracking and attribution of software application related conversion events. As shown in FIG. 6:

A hypothetical application developer owns website KingOfRPG.com and its subdomains.

the application developer publishes a gaming application called King of RPG

the user, whether acquired through a paid, direct or organic traffic, will be able to initially experience the mobile game within the (PC or mobile) browser, on a subdomain of KingOfRPG.com, through a cloud services based instance of the mobile game.

The user will be marked as ‘converted’ if they choose to experience the game online, and this information can be sent back to an advertiser network if the user was acquired through a paid channel.

If the user wishes, she/he can continue the journey by downloading the mobile application on their iOS or Android device. For this purpose, the conversion tracking server will generate a random identifier, named web_idfv™ and will be connected to this web user in the unique tracking link generated for the user.

Once the application is installed and opened for the first time in the mobile device, it will be able to link the mobile device to the user who experienced the game on their own website. This will be done through a probabilistic fingerprinting method.

Optionally, the unique identifier generated by the conversion tracking server (for example, an identifier named ‘web_idfv’) will allow for the user state in the software application/mobile game during the web experience (i.e. in the cloud services based instance of the game to be propagated seamlessly to the mobile device, in case of sensitive information, the user can choose to sign-in on both web and mobile devices as the probabilistic fingerprinting method will not be 100% accurate. The information arising from the user behaviour on the mobile device (such as tutorial completion rate, payment or other events of interest to the application developer) can be used to optimize the original web acquisition channels.

The above described invention offers multiple advantages.

The conversion event tracking and attribution information relating to user behaviour on the mobile device (such as tutorial completion rate, payment or other events of interest to the application developer) can be used to optimize the original web acquisition channels and improve targeted delivery of content to the user.

The invention additionally enables an optimized conversion funnel. By allowing the users to experience a software application/game by first interacting with a cloud based instance of the software application/game before committing to a large application download, the chances of the user converting to a loyal user will increase—which usually translates to better usage, retention and payment metrics, and thereby further improves targeted delivery of content to the user.

Additionally, by redirecting a user to a webpage where the user can first interact with a cloud instance of a software application/game, the invention enables for internet based/web based/browser based advertisements to continue to be optimized in a way which would not otherwise be possible if advertisements were to lead directly to an application download on a mobile device—particularly in view of the anticipated restrictions on retrieval of identifiers associated with a mobile device and passing of such identifiers and other information to third parties such as attribution platforms are likely to be implemented in the near future.

In an exemplary method embodiment, the invention comprises a method for network based tracking of electronic advertisement conversion, comprising implementing at a conversion tracking server, the steps of (i) receiving, from a referral source that has initiated display of an advertisement for a software application on a terminal device web browser, traffic parameters associated with a user click event corresponding to the displayed advertisement, (ii) responsive to receiving, from the terminal device, a first user input initiating network based delivery of a cloud implemented instance of the software application to the terminal device (a) generating a unique identifier associated with an ongoing network communication session between the terminal device and the conversion tracking server, (b) generating a first device fingerprint associated with the terminal device, (c) associating the generated first device fingerprint with the generated unique identifier, (d) retrievably storing the generated first device fingerprint with the generated first unique identifier in a device fingerprint database; and (e) transmitting to the referral source or to an entity associated with the referral source, a first conversion event confirmation message confirming that delivery of the cloud implemented instance of the software application to the terminal device has been initiated, (iii) receiving, from the terminal device, a second user input initiating download of the software application onto the terminal device, and implementing download of the software application from an application store database, onto the terminal device, (iv) responsive to launch of a runtime instance of the downloaded software application on the terminal device (f) receiving from the terminal device, a runtime event confirmation message, (g) receiving from the terminal device, terminal device fingerprint data, (h) generating a second device fingerprint based on the received terminal device fingerprint data, (i) comparing the second device fingerprint against device fingerprint data stored in the device fingerprint database, (j) responsive to detecting a positive match between the second device fingerprint and the first device fingerprint (1) retrieving the unique identifier associated with the first device fingerprint, and (2) transmitting to the referral source or to the entity associated with the referral source, a second conversion event confirmation message confirming launch of the runtime instance of the downloaded software application on the terminal device.

In an embodiment of the method, the first conversion event confirmation message and the second conversion event confirmation message enable the referral source or the entity associated with the referral source to correlate both conversion event confirmation messages to determine that the launch of the runtime instance of the downloaded software application on the terminal device is attributed to the referral source.

In another method embodiment, responsive to detecting the positive match between the second device fingerprint and the first device fingerprint, the conversion tracking server additionally transmits to the referral source or to the entity associated with the referral source, information relating to the network communication session in which the first device fingerprint has been generated.

In a particular method embodiment the traffic parameters associated with a user click event corresponding to the displayed advertisement include one or more of a campaign ID associated with the displayed advertisement, and a referral source ID associated with the referral source.

In an exemplary embodiment of the method, the delivery of a cloud implemented instance of the software application to the terminal device is implemented by a cloud services server system.

In one embodiment of the method the first device fingerprint or the terminal device fingerprint data received by the conversion tracking server from the terminal device, includes any one or more of a terminal device name, terminal device type, terminal device operating system (OS) version, terminal device IP information, and network carrier information associated with the terminal device.

In a particular embodiment of the method, transmission of the first conversion event confirmation message to the referral source or to the entity associated with the referral source, includes transmission of data identifying the ongoing network communication session between the terminal device and the conversion tracking server.

The invention also provides a system for network based tracking of electronic advertisement conversion, comprising a processor based conversion tracking server configured for implementing the steps of: (i) receiving, from a referral source that has initiated display of an advertisement for a software application on a terminal device web browser, traffic parameters associated with a user click event corresponding to the displayed advertisement, (ii) responsive to receiving, from the terminal device, a first user input initiating network based delivery of a cloud implemented instance of the software application to the terminal device (a) generating a unique identifier associated with an ongoing network communication session between the terminal device and the conversion tracking server, (b) generating a first device fingerprint associated with the terminal device, (c) associating the generated first device fingerprint with the generated unique identifier, (d) retrievably storing the generated first device fingerprint with the generated first unique identifier in a device fingerprint database; and (e) transmitting to the referral source or to an entity associated with the referral source, a first conversion event confirmation message confirming that delivery of the cloud implemented instance of the software application to the terminal device has been initiated, (iii) receiving, from the terminal device, a second user input initiating download of the software application onto the terminal device, and implementing download of the software application from an application store database, onto the terminal device, (iv) responsive to launch of a runtime instance of the downloaded software application on the terminal device (f) receiving from the terminal device, a runtime event confirmation message, (g) receiving from the terminal device, terminal device fingerprint data, (h) generating a second device fingerprint based on the received terminal device fingerprint data, (l) comparing the second device fingerprint against device fingerprint data stored in the device fingerprint database, (j) responsive to detecting a positive match between the second device fingerprint and the first device fingerprint (1) retrieving the unique identifier associated with the first device fingerprint, and (2) transmitting to the referral source or to the entity associated with the referral source, a second conversion event confirmation message confirming launch of the runtime instance of the downloaded software application on the terminal device.

In an embodiment of the system, as claimed in claim 1 the first conversion event confirmation message and the second conversion event confirmation message enable the referral source or the entity associated with the referral source to correlate both conversion event confirmation messages to determine that the launch of the runtime instance of the downloaded software application on the terminal device is attributed to the referral source.

In another system embodiment, responsive to detecting the positive match between the second device fingerprint and the first device fingerprint, the conversion tracking server additionally transmits to the referral source or to the entity associated with the referral source, information relating to the network communication session in which the first device fingerprint has been generated.

In a particular system embodiment the traffic parameters associated with a user click event corresponding to the displayed advertisement include one or more of a campaign ID associated with the displayed advertisement, and a referral source ID associated with the referral source.

In an exemplary embodiment of the system, the delivery of a cloud implemented instance of the software application to the terminal device is implemented by a cloud services server system.

In one embodiment of the system the first device fingerprint or the terminal device fingerprint data received by the conversion tracking server from the terminal device, includes any one or more of a terminal device name, terminal device type, terminal device operating system (OS) version, terminal device IP information, and network carrier information associated with the terminal device.

In a particular embodiment of the system, transmission of the first conversion event confirmation message to the referral source or to the entity associated with the referral source, includes transmission of data identifying the ongoing network communication session between the terminal device and the conversion tracking server.

The invention also provides an embodiment comprising a computer program product for network based tracking of electronic advertisement conversion. The computer program product comprises a non-transitory computer readable medium having a computer readable program code embodied therein, the computer readable program code comprising instructions for implementing the steps of (i) receiving, from a referral source that has initiated display of an advertisement for a software application on a terminal device web browser, traffic parameters associated with a user click event corresponding to the displayed advertisement, (ii) responsive to receiving, from the terminal device, a first user input initiating network based delivery of a cloud implemented instance of the software application to the terminal device (a) generating a unique identifier associated with an ongoing network communication session between the terminal device and the conversion tracking server, (b) generating a first device fingerprint associated with the terminal device, (c) associating the generated first device fingerprint with the generated unique identifier, (d) retrievably storing the generated first device fingerprint with the generated first unique identifier in a device fingerprint database; and (e) transmitting to the referral source or to an entity associated with the referral source, a first conversion event confirmation message confirming that delivery of the cloud implemented instance of the software application to the terminal device has been initiated, (iii) receiving, from the terminal device, a second user input initiating download of the software application onto the terminal device, and implementing download of the software application from an application store database, onto the terminal device, (iv) responsive to launch of a runtime instance of the downloaded software application on the terminal device (f) receiving from the terminal device, a runtime event confirmation message, (g) receiving from the terminal device, terminal device fingerprint data, (h) generating a second device fingerprint based on the received terminal device fingerprint data, (l) comparing the second device fingerprint against device fingerprint data stored in the device fingerprint database, (j) responsive to detecting a positive match between the second device fingerprint and the first device fingerprint (1) retrieving the unique identifier associated with the first device fingerprint, and (2) transmitting to the referral source or to the entity associated with the referral source, a second conversion event confirmation message confirming launch of the runtime instance of the downloaded software application on the terminal device.

In an embodiment of the computer program product, the first conversion event confirmation message and the second conversion event confirmation message enable the referral source or the entity associated with the referral source to correlate both conversion event confirmation messages to determine that the launch of the runtime instance of the downloaded software application on the terminal device is attributed to the referral source.

In another computer program product embodiment, responsive to detecting the positive match between the second device fingerprint and the first device fingerprint, the conversion tracking server additionally transmits to the referral source or to the entity associated with the referral source, information relating to the network communication session in which the first device fingerprint has been generated.

In a particular computer program product embodiment the traffic parameters associated with a user click event corresponding to the displayed advertisement include one or more of a campaign ID associated with the displayed advertisement, and a referral source ID associated with the referral source.

In an exemplary embodiment of the computer program product, the delivery of a cloud implemented instance of the software application to the terminal device is implemented by a cloud services server system.

In one embodiment of the computer program product, the first device fingerprint or the terminal device fingerprint data received by the conversion tracking server from the terminal device, includes any one or more of a terminal device name, terminal device type, terminal device operating system (OS) version, terminal device IP information, and network carrier information associated with the terminal device.

In a particular embodiment of the computer program product, transmission of the first conversion event confirmation message to the referral source or to the entity associated with the referral source, includes transmission of data identifying the ongoing network communication session between the terminal device and the conversion tracking server.

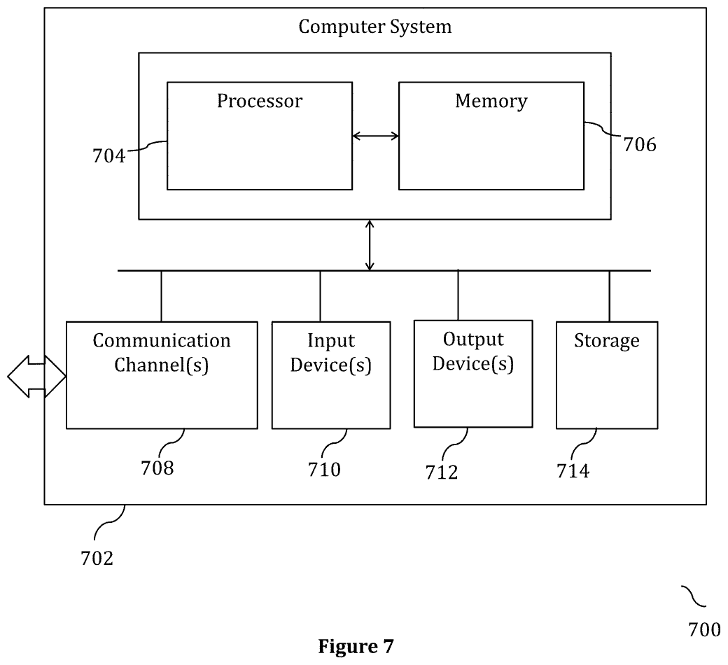

FIG. 7 illustrates an exemplary system for implementing the present invention.

FIG. 7 illustrates an exemplary system 700 for implementing the present invention. The illustrated system 700 comprises computer system 702 which in turn comprises one or more processors 704 and at least one memory 706. Processor 704 is configured to execute program instructions—and may be a real processor or a virtual processor. It will be understood that computer system 702 does not suggest any limitation as to scope of use or functionality of described embodiments. The computer system 702 may include, but is not be limited to, one or more of a general-purpose computer, a programmed microprocessor, a micro-controller, an integrated circuit, and other devices or arrangements of devices that are capable of implementing the steps that constitute the method of the present invention. Exemplary embodiments of a computer system 702 in accordance with the present invention may include one or more servers, desktops, laptops, tablets, smart phones, mobile phones, mobile communication devices, tablets, phablets and personal digital assistants. In an embodiment of the present invention, the memory 706 may store software for implementing various embodiments of the present invention. The computer system 702 may have additional components. For example, the computer system 702 may include one or more communication channels 708, one or more input devices 710, one or more output devices 712, and storage 714. An interconnection mechanism (not shown) such as a bus, controller, or network, interconnects the components of the computer system 702. In various embodiments of the present invention, operating system software (not shown) provides an operating environment for various softwares executing in the computer system 702 using a processor 704, and manages different functionalities of the components of the computer system 702.

The communication channel(s) 708 allow communication over a communication medium to various other computing entities. The communication medium provides information such as program instructions, or other data in a communication media. The communication media includes, but is not limited to, wired or wireless methodologies implemented with an electrical, optical, RF, infrared, acoustic, microwave, Bluetooth or other transmission media.

The input device(s) 710 may include, but is not limited to, a touch screen, a keyboard, mouse, pen, joystick, trackball, a voice device, a scanning device, or any another device that is capable of providing input to the computer system 702. In an embodiment of the present invention, the input device(s) 710 may be a sound card or similar device that accepts audio input in analog or digital form. The output device(s) 712 may include, but not be limited to, a user interface on CRT, LCD, LED display, or any other display associated with any of servers, desktops, laptops, tablets, smart phones, mobile phones, mobile communication devices, tablets, phablets and personal digital assistants, printer, speaker, CD/DVD writer, or any other device that provides output from the computer system 702.

The storage 714 may include, but not be limited to, magnetic disks, magnetic tapes, CD-ROMs, CD-RWs, DVDs, any types of computer memory, magnetic stripes, smart cards, printed barcodes or any other transitory or non-transitory medium which can be used to store information and can be accessed by the computer system 702. In various embodiments of the present invention, the storage 714 may contain program instructions for implementing any of the described embodiments.

In an embodiment of the present invention, the computer system 702 is part of a distributed network or a part of a set of available cloud resources.

The present invention may be implemented in numerous ways including as a system, a method, or a computer program product such as a computer readable storage medium or a computer network wherein programming instructions are communicated from a remote location.

The present invention may suitably be embodied as a computer program product for use with the computer system 702. The method described herein is typically implemented as a computer program product, comprising a set of program instructions that is executed by the computer system 702 or any other similar device. The set of program instructions may be a series of computer readable codes stored on a tangible medium, such as a computer readable storage medium (storage 714), for example, diskette, CD-ROM, ROM, flash drives or hard disk, or transmittable to the computer system 702, via a modem or other interface device, over either a tangible medium, including but not limited to optical or analogue communications channel(s) 708. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the Internet or a mobile telephone network. The series of computer readable instructions may embody all or part of the functionality previously described herein.

The invention accordingly enables cross-device authentication for implementation within cloud based service systems, and more particularly within cloud gaming systems.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims. Additionally, the invention illustratively disclose herein suitably may be practiced in the absence of any element which is not specifically disclosed herein and in a particular embodiment specifically contemplated, is intended to be practiced in the absence of any element which is not specifically disclosed herein.

We claim:

1. A method for network based tracking of electronic advertisement conversion, comprising implementing at a conversion tracking server, the steps of: receiving, from a referral source that has initiated display of an advertisement for a software application on a terminal device web browser, traffic parameters associated with a user click event corresponding to the displayed advertisement;
responsive to receiving, from the terminal device, a first user input initiating network based delivery of a cloud implemented instance of the software application to the terminal device:
generating a unique identifier associated with an ongoing network communication session between the terminal device and the conversion tracking server;
generating a first device fingerprint associated with the terminal device;
associating the generated first device fingerprint with the generated unique identifier;
retrievably storing the generated first device fingerprint with the generated first unique identifier in a device fingerprint database; and
transmitting to the referral source or to an entity associated with the referral source, a first conversion event confirmation message confirming that delivery of the cloud implemented instance of the software application to the terminal device has been initiated;
receiving, from the terminal device, a second user input initiating download of the software application onto the terminal device, and implementing download of the software application from an application store database, onto the terminal device;
responsive to launch of a runtime instance of the downloaded software application on the terminal device:
receiving from the terminal device, a runtime event confirmation message;
receiving from the terminal device, terminal device fingerprint data;
generating a second device fingerprint based on the received terminal device fingerprint data;
comparing the second device fingerprint against device fingerprint data stored in the device fingerprint database;
responsive to detecting a positive match between the second device fingerprint and the first device fingerprint:
retrieving the unique identifier associated with the first device fingerprint;
and transmitting to the referral source or to the entity associated with the referral source, a second conversion event confirmation message confirming launch of the runtime instance of the downloaded software application on the terminal device.

2. The method as claimed in claim 1, wherein the first conversion event confirmation message and the second conversion event confirmation message enable the referral source or the entity associated with the referral source to correlate both conversion event confirmation messages to determine that the launch of the runtime instance of the downloaded software application on the terminal device is attributed to the referral source.

3. The method as claimed in claim 1, wherein responsive to detecting the positive match between the second device fingerprint and the first device fingerprint, the conversion tracking server additionally transmits to the referral source or to the entity associated with the referral source, information relating to the network communication session in which the first device fingerprint has been generated.

4. The method as claimed in claim 1, wherein the traffic parameters associated with a user click event corresponding to the displayed advertisement include one or more of a campaign ID associated with the displayed advertisement, and a referral source ID associated with the referral source.

5. The method as claimed in claim 1, wherein the delivery of a cloud implemented instance of the software application to the terminal device is implemented by a cloud services server system.

6. The method as claimed in claim 1, wherein, the first device fingerprint or the terminal device fingerprint data received by the conversion tracking server from the terminal device, includes any one or more of a terminal device name, terminal device type, terminal device operating system (OS) version, terminal device IP information, and network carrier information associated with the terminal device.

7. The method as claimed in claim 1, wherein transmission of the first conversion event confirmation message to the referral source or to the entity associated with the referral source, includes transmission of data identifying the ongoing network communication session between the terminal device and the conversion tracking server.

8. A system for network based tracking of electronic advertisement conversion, comprising a processor based conversion tracking server configured for implementing the steps of:
receiving, from a referral source that has initiated display of an advertisement for a software application on a terminal device web browser, traffic parameters associated with a user click event corresponding to the displayed advertisement;
responsive to receiving, from the terminal device, a first user input initiating network based delivery of a cloud implemented instance of the software application to the terminal device:
generating a unique identifier associated with an ongoing network communication session between the terminal device and the conversion tracking server;
generating a first device fingerprint associated with the terminal device;
associating the generated first device fingerprint with the generated unique identifier;
retrievably storing the generated first device fingerprint with the generated first unique identifier in a device fingerprint database; and
transmitting to the referral source or to an entity associated with the referral source, a first conversion event confirmation message confirming that delivery of the cloud implemented instance of the software application to the terminal device has been initiated;
receiving, from the terminal device, a second user input initiating download of the software application onto the terminal device, and implementing download of the software application from an application store database, onto the terminal device;
responsive to launch of a runtime instance of the downloaded software application on the terminal device:
receiving from the terminal device, a runtime event confirmation message;
receiving from the terminal device, terminal device fingerprint data;
generating a second device fingerprint based on the received terminal device fingerprint data;
comparing the second device fingerprint against device fingerprint data stored in the device fingerprint database;
responsive to detecting a positive match between the second device fingerprint and the first device fingerprint:
retrieving the unique identifier associated with the first device fingerprint;
and transmitting to the referral source or to the entity associated with the referral source, a second conversion event confirmation message confirming launch of the runtime instance of the downloaded software application on the terminal device.

9. The system as claimed in claim 8, wherein the first conversion event confirmation message and the second conversion event confirmation message enable the referral source or the entity associated with the referral source to correlate both conversion event confirmation messages to determine that the launch of the runtime instance of the downloaded software application on the terminal device is attributed to the referral source.

10. The system as claimed in claim 8, wherein responsive to detecting the positive match between the second device fingerprint and the first device fingerprint, the conversion tracking server additionally transmits to the referral source or to the entity associated with the referral source, information relating to the network communication session in which the first device fingerprint has been generated.

11. The system as claimed in claim 8, wherein the traffic parameters associated with a user click event corresponding to the displayed advertisement include one or more of a campaign ID associated with the displayed advertisement, and a referral source ID associated with the referral source.

12. The system as claimed in claim 8 wherein the delivery of a cloud implemented instance of the software application to the terminal device is implemented by a cloud services server system.

13. The system as claimed in claim 8, wherein, the first device fingerprint or the terminal device fingerprint data received by the conversion tracking server from the terminal device, includes any one or more of a terminal device name, terminal device type, terminal device operating system (OS) version, terminal device IP information, and network carrier information associated with the terminal device.

14. The system as claimed in claim 8, wherein transmission of the first conversion event confirmation message to the referral source or to the entity associated with the referral source, includes transmission of data identifying the ongoing network communication session between the terminal device and the conversion tracking server.

15. A computer program product for network based tracking of electronic advertisement conversion, comprising a non-transitory computer readable medium having a computer readable program code embodied therein, the computer readable program code comprising instructions for implementing the steps of:
receiving, from a referral source that has initiated display of an advertisement for a software application on a terminal device web browser, traffic parameters associated with a user click event corresponding to the displayed advertisement;
responsive to receiving, from the terminal device, a first user input initiating network based delivery of a cloud implemented instance of the software application to the terminal device:
generating a unique identifier associated with an ongoing network communication session between the terminal device and the conversion tracking server;
generating a first device fingerprint associated with the terminal device;
associating the generated first device fingerprint with the generated unique identifier;
retrievably storing the generated first device fingerprint with the generated first unique identifier in a device fingerprint database; and
transmitting to the referral source or to an entity associated with the referral source, a first conversion event confirmation message confirming that delivery of the cloud implemented instance of the software application to the terminal device has been initiated;
receiving, from the terminal device, a second user input initiating download of the software application onto the terminal device, and implementing download of the software application from an application store database, onto the terminal device;
responsive to launch of a runtime instance of the downloaded software application on the terminal device:
receiving from the terminal device, a runtime event confirmation message;
receiving from the terminal device, terminal device fingerprint data;
generating a second device fingerprint based on the received terminal device fingerprint data;
comparing the second device fingerprint against device fingerprint data stored in the device fingerprint database;
responsive to detecting a positive match between the second device fingerprint and the first device fingerprint:
retrieving the unique identifier associated with the first device fingerprint;
and transmitting to the referral source or to the entity associated with the referral source, a second conversion event confirmation message confirming launch of the runtime instance of the downloaded software application on the terminal device.
